(19) United States
(12) Patent Application Publication
(10) Pub. No.: US 2025/0313237 A1
(43) Pub. Date: Oct. 9, 2025

(54) VEHICLE

(71) Applicant: TOYOTA JIDOSHA KABUSHIKI KAISHA, Toyota-shi (JP)

(72) Inventors: Hirohito IDE, Nagoya-shi (JP); Hiroki Asao, Kobe-shi (JP)

(73) Assignee: TOYOTA JIDOSHA KABUSHIKI KAISHA, Toyota-shi (JP)

(21) Appl. No.: 19/035,018

(22) Filed: Jan. 23, 2025

(30) Foreign Application Priority Data
Apr. 4, 2024 (JP) 2024-060617

(51) Int. Cl. B60W 60/00; B60Q 1/46; B60Q 5/00; B60W 50/035

(52) U.S. Cl. CPC B60W 60/00186; B60Q 1/46; B60Q 5/005; B60W 50/035

(57) ABSTRACT

VP is configured to perform deceleration control when an anomaly occurs in communication between VCIB and ADK. VCIB is configured to receive a command from ADK whether to perform horn control that activates the horn of VP when the deceleration control is executed, or hazard warning lamp control that activates the hazard warning lamp of VP when the deceleration control is executed.

### CROSS-REFERENCE TO RELATED APPLICATION

This application claims priority to Japanese Patent Application No. 2024-060617 filed on Apr. 4, 2024, incorporated herein by reference in its entirety.

### BACKGROUND

### 1. Technical Field

The present disclosure relates to a vehicle including an autonomous driving system.

### 2. Description of Related Art

Japanese Unexamined Patent Application Publication No. 2018-132015 (JP 2018-132015 A) discloses a vehicle equipped with an autonomous driving system. This vehicle is equipped with a motive power system, an electric power supply system, and an autonomous driving system. The motive power system comprehensively manages motive power of the vehicle. The electric power supply system comprehensively manages electric power supply of the vehicle. The autonomous driving system comprehensively executes autonomous driving control of the vehicle. Electronic control units (ECUs) of the motive power system, the electric power supply system, and the autonomous driving system, are each communicably connected to each other through an in-vehicle network (see JP 2018-132015 A).

### SUMMARY

It is conceivable that the autonomous driving system (autonomous driving kit) is externally installed to a vehicle proper (vehicle platform). In this case, autonomous driving is realized by connecting the autonomous driving kit to the vehicle platform by communication, and controlling the vehicle in accordance with commands from the autonomous driving kit. When an abnormality occurs in communication between the autonomous driving kit and the vehicle platform during autonomous driving, deceleration control for stopping the vehicle is executed in the vehicle platform.

During the execution of the deceleration control, it is conceivable to activate a horn or a hazard warning lamp in order to alert those in the vicinity of the vehicle. However, usage of the horn is prohibited on freeways in some States in North America, for example, and unconditional operation of the horn could be illegal. Also, lighting of the hazard warning lamp while traveling might hinder effects of brake lamps (stipulated lamp effects), and unconditional operation of the hazard warning lamp might be illegal as well.

The present disclosure has been made to solve such a problem. An object of the present disclosure is to enable appropriately setting whether to activate a horn and/or a hazard warning lamp at the time of deceleration control that is executed when an abnormality occurs in communication with an autonomous driving kit during autonomous driving, in accordance with the region that is being traveled and other conditions.

The vehicle according to the present disclosure is a vehicle that is configured to be equipped with an autonomous driving kit (ADK), and includes a base vehicle for controlling the vehicle, and a vehicle control interface box (VCIB) for performing communication with the ADK.

The vehicle is configured to execute deceleration control in an event of an abnormality in communication between the VCIB and the ADK.
The VCIB is configured to receive a command from the ADK regarding whether to execute horn control for activating a horn of the vehicle when the deceleration control is executed, or to execute hazard warning lamp control for activating a hazard warning lamp of the vehicle when the deceleration control is executed.

According to such a configuration, the ADK can set whether to execute horn control or hazard warning lamp control at the time of executing deceleration control when an abnormality occurs in communication between the VCIB and the ADK. Accordingly, whether to activate the horn or the hazard warning lamp at the time of executing the deceleration control can be appropriately set from the ADK in accordance with the region that is being traveled and other conditions.

The VCIB may be configured to receive, from the ADK, a command that instructs an operation pattern of the horn in the horn control.

Also, the VCIB may be configured to receive, from the ADK, a command that instructs an operation end timing of the horn in the horn control.

The command that instructs the operation end timing of the horn may include a command that instructs that the operation end timing is a time at which the vehicle is fixed, or a command that instructs that the operation end timing is when the vehicle in system-off.

The base vehicle may be configured to accept stopping of the hazard warning lamp by a user of the vehicle when the hazard warning lamp control is executed.

According to the vehicle of the present disclosure, whether to activate the horn and/or the hazard warning lamp can be appropriately switched depending on the region that is being travelled and other conditions, during the deceleration control that is executed when abnormal communication with the ADK occurs during autonomous driving.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a vehicle according to an embodiment;

FIG. 2 is a diagram illustrating a schematic configuration of a communication system of a vehicle;

FIG. 3A is a diagram illustrating an example of an API command used in vehicles;

FIG. 3B is a diagram illustrating an example of an API command used in vehicles;

FIG. 3C is a diagram illustrating an example of an API command used in vehicles;

FIG. 4 is a flowchart illustrating an example of a procedure of horn control executed at the time of deceleration control;

FIG. 5 is a diagram illustrating an API command requesting lighting of a hazard warning lamp at the time of deceleration control in Embodiment 2; and

FIG. 6 is a flowchart illustrating an example of a processing procedure of hazard warning lamp control executed at the time of deceleration control.

### DETAILED DESCRIPTION OF EMBODIMENTS

Hereinafter, embodiments of the present disclosure will be described in detail with reference to the drawings. In the following, a plurality of embodiments will be described, but the configuration described in each embodiment will be appropriately combined from the beginning of the application. In the drawings, the same or corresponding parts are denoted by the same reference numerals, and the description thereof will not be repeated.

### First Embodiment

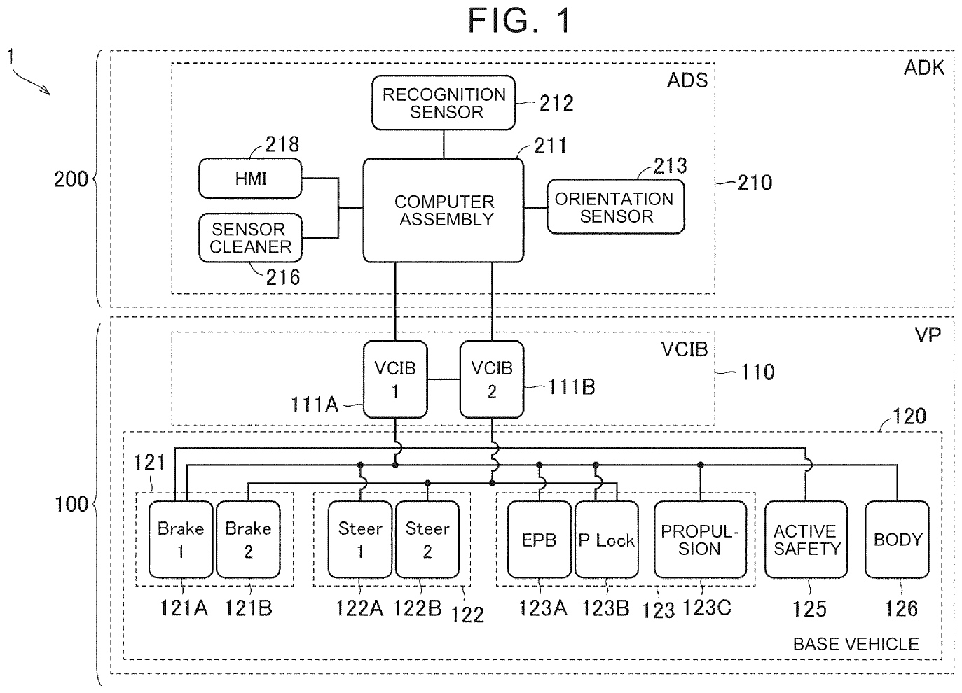

FIG. 1 is a diagram illustrating a schematic configuration of a vehicle according to an embodiment. Referring to FIG. 1, a vehicle 1 includes a VP (vehicle platform) 100 and a ADK (autonomous driving kit) 200. VP 100 includes a VCIB (Vehicle Control Interface Box) 110 and a base vehicle 120. By adding VCIB 110 to the base vehicle 120, a ADK 200 detachable VP 100 is configured, and the vehicle 1 is configured by attaching a ADK 200 to VP 100.

The base vehicle 120 is, for example, a commercially available xEV (electrified vehicle), and in the present embodiment, BEV (battery electric vehicle), but may be a xEV other than BEV. In the present embodiment, ADK 200 is attached to the rooftop of the base vehicle 120. Note that the attachment position of ADK 200 to the base vehicle 120 may be another position.

ADK 200 includes an autonomous driving system autonomous driving System (ADS) 210 that executes various processes related to autonomous driving. ADS 210 includes a computer assembly 211, a recognition sensor 212, an attitude sensor 213, a sensor cleaner 216, and a Human Machine Interface (HMI) 218.

The computer assembly 211 includes a processor and a storage device for storing autonomous driving software using Application Program Interface (API) described later. The processor is configured to execute the autonomous driving software. The recognition sensor 212 includes a sensor that acquires information indicating an external environment of the vehicle 1. The recognition sensor 212 may include at least one of a camera, a millimeter wave radar, and a lidar. The attitude sensor 213 acquires information about the attitude of the vehicle 1. The attitude sensor 213 may include various sensors for detecting acceleration, angular velocity, and position of the vehicle 1. HMI 218 includes an inputting device and a notification device.

The base vehicle 120 includes a brake system 121, a steering system 122, a powertrain system 123, an active safety system 125, and a body system 126. In the present embodiment, ECU is included.

VCIB 110 is configured to communicate with both the base vehicle 120 and ADK 200 via a communication bus. The physical communication may be communication using Controller Area Network (CAN). In the vehicle 1, a control system related to the behavior (running, stopping, and bending) of the vehicle 1 has redundancy. VCIB 110 includes VCIB 111A (VCIB1) of the main-control system and VCIB 111B (VCIB2) of the sub-control system.

The brake system 121 includes a brake mechanism, an operation unit that receives a brake operation from a driver, and a brake control unit 121A, 121B. The steering system 122 includes a steering mechanism, an operation unit that receives a steering operation from a driver, and a steering control unit 122A, 122B.

The powertrain system 123 includes a shifting device, a vehicle drive, EPB device, a P-Lock device, a 123A of EPB controls, a 123B of P-Lock controls, and a 123C of propulsion controls. “EPB” means electric parking brake, and “P-Lock” means parking lock. The shift device includes an operation unit that receives a shift operation from the driver, and determines a shift range of the vehicle. The vehicle driving device includes a driving battery and a traveling motor to which electric power is supplied from the driving battery, and applies a propulsive force in a propulsion direction indicated by the shift range. P-Lock device further includes an operation unit configured to receive a parking operation from the driver in addition to the parking lock mechanism and the actuator.

The active safety system 125 uses a camera/radar (not shown) to perform vehicle control to avoid collision or reduce damage. The active safety system 125 is communicatively coupled to the brake system 121A. The active safety system 125 detects a front obstacle (an obstacle or a person) using, for example, a camera/radar. When it is determined that there is a possibility of a collision due to a distance from an obstacle or the like, a braking command is outputted to the brake system 121A so that the braking force is increased.

The body system 126 is configured to be capable of controlling components such as a direction indicator, a horn, a hazard warning lamp, and a wiper according to, for example, a traveling state or a traveling environment of the vehicle. The body system 126 can control the above-described components according to predetermined control commands received from ADK 200 via VCIB 110.

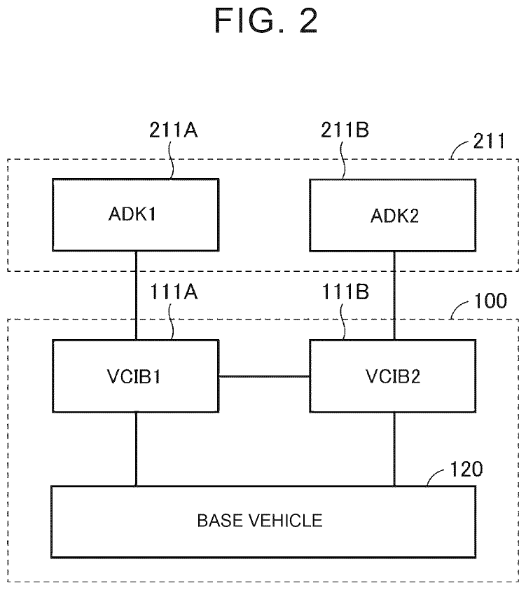

FIG. 2 is a diagram illustrating a schematic configuration of a communication system of the vehicle 1. Referring to FIG. 2, a ADK 200 computer assembly 211 (FIG. 1) includes a main-based computer module 211A and a sub-based computer module 211B. Hereinafter, the computer module 211A is referred to as “ADK 211A” or “ADK 1”. The computer module 211B is referred to as “ADK 211B” or “ADK2.” Each of ADK 211A, 211B includes a processor and a storage device that stores autonomous driving software using API.

VCIB 111A, 111B are each configured to communicate with ADK 211A, ADK 211B via CAN communication through communication busses. Also, VCIB 111A and VCIB 111B are configured to be able to communicate with each other.

In the vehicle 1, various commands for autonomous driving are usually transmitted from ADK 211A of the main system to VCIB 111A, and various commands are transmitted to the base vehicle 120. When an error (including a ADK 211A failure) occurs in the communication between ADK 211A and VCIB 111A, a command for executing limp home from ADK 211B of the sub-system to VCIB 111B is transmitted. In accordance with the command, the base vehicle 120 performs limp home.

In addition to the communication abnormality between ADK 211A and VCIB 111A, when an abnormality (including a failure of ADK 211B) also occurs in the communication between ADK 211B and VCIB 111B, the deceleration control for stopping the vehicles in VP 100 is executed. Hereinafter, the “deceleration control” means a deceleration control executed when an error occurs in communication with both of ADK 211A, 211B.

In the present embodiment, the above-described deceleration control is executed by a VCIB 110 (for example, a VCIB 111A). That is, VCIB 110 is designed (programmed) so as to execute the deceleration control when an abnormal communication with both ADK 211A, 211B occurs. It should be noted that the deceleration control may be performed in the base vehicle 120 (e.g., using the brake system 121 and the active safety system 125 (FIG. 1)) rather than in VCIB 110.

During the execution of the deceleration control, it is conceivable to operate the horn of the base vehicle 120 for the purpose of calling attention to the surroundings of the vehicle. However, as discussed above, unconditionally activating the horn may be illegal in some areas of travel.

Therefore, in the first embodiment, a command is provided as to whether or not to execute horn control for activating the horn when the deceleration control is executed, and such a command is given from ADK 200 to VCIB 110 of VP 100. In the following, the term “horn control” shall mean control to activate the horn when the deceleration control is executed. That is, VCIB 110 (VCIB 111A) is configured to receive a command from ADK 200 (ADK 211A) whether or not to execute horn control.

ADK 211A periodically transmits a command instructing the horn control to be executed to VCIB 111A according to the area in which the vehicle 1 is traveling. For example, when the vehicle 1 is traveling in an area where the use of the horn is not prohibited, ADK 211A periodically transmits a command for requesting the horn to be blown to VCIB 111A at the time of deceleration control. On the other hand, when the vehicle 1 is traveling on the freeway in an area where the use of the horn in the freeway is prohibited, ADK 211A transmits a command to VCIB 111A that does not require the horn blowing at the time of the deceleration control.

Further, for the horn, it is necessary to consider the degree of attention calling to the surroundings and the influence of the sound of the horn on the surrounding environment, in the first embodiment, a command for instructing the operation pattern of the horn in the horn control and a command for instructing the operation end timing of the horn in the horn control are further provided. These commands are given from ADK 200 to VCIB 110. That is, VCIB 110 (VCIB 111A) is configured to receive a command instructing an operation pattern of the horn in the horn control and a command instructing an operation termination timing of the horn in the horn control from ADK 200 (ADK 211A).

In the first embodiment, as the operation pattern of the horn, a pattern in which the horn is continuously blown and a pattern in which the horn is intermittently blown can be set. For the latter, a plurality of patterns having different intervals at which the horn is blown may be prepared. The operation pattern of the horn may be appropriately set according to, for example, a region or a time zone in which the vehicle 1 is traveling, or may be settable at the time of manufacture or at a dealer.

Further, in the first embodiment, it is possible to set the timing when the vehicle is fixed (when EPB device or P-Lock device is operated) and the timing when the horn is IG-OFF (when VP 100 is system-off). The operation end timing of the horn may also be appropriately set according to, for example, a region or a time zone in which the vehicle 1 is traveling, or may be set at the time of manufacture or at a dealer.

A signal defined by API (API signal) is used for communication between ADK 200 and VCIB 110. ADK 200 outputs various commands according to API to VCIB 110, and receives various commands from ADK 200 according to API by VCIB 110. Hereinafter, the various commands outputted from ADK 200 to VCIB 110 are also referred to as “API commands”.

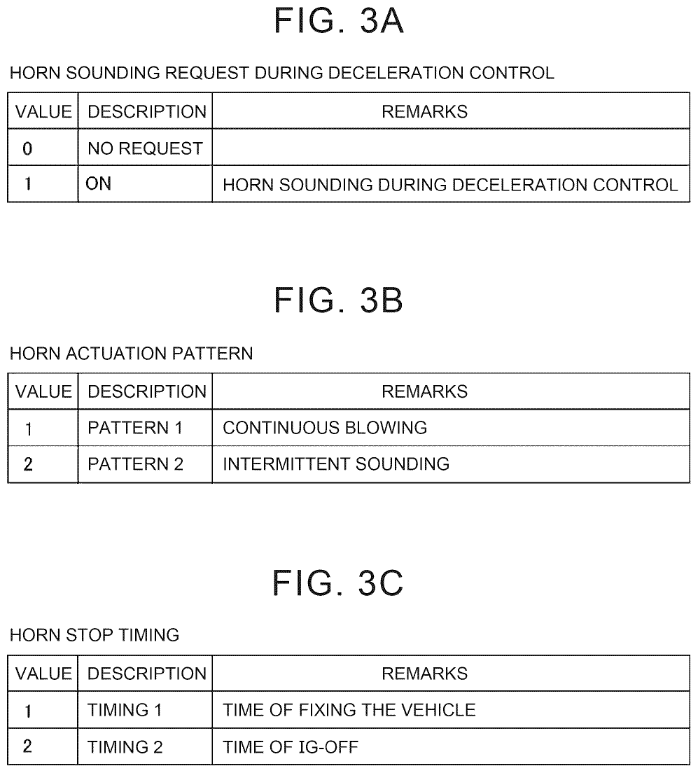

FIGS. 3A to 3C are diagrams illustrating an example of API commands used in vehicles 1. The FIG. 3A shows an API commanding for sounding horns during deceleration control. That is, this API command is for instructing whether or not to execute horn control from ADK 200 to VP 100 at the time of deceleration control. When the value of API command is 1, the horn is required to be blown during deceleration control, and when the value is 0, the horn is not required to be blown during deceleration control.

The FIG. 3B shows an API command requesting an actuation pattern of the horn in horn control. That is, API command is for instructing the horn operation pattern in the horn control from ADK 200 to VP 100. If the value of API command is 1, a continuous blowing is required to continuously blow the horn, and if the value is 2, an interval blowing is required to intermittently blow the horn.

The FIG. 3C shows an API commanding requesting the stopping timing of the horn in horn control. That is, this API command is for instructing the stopping timing of the horn in the horn control from ADK 200 to VP 100. When API command is 1, the horn is required to be stopped when the vehicle is fixed (when EPB device or P-Lock device is operated). If it is 2, it is required to shut down the horn at IG-OFF (when VP 100 is in system-off).

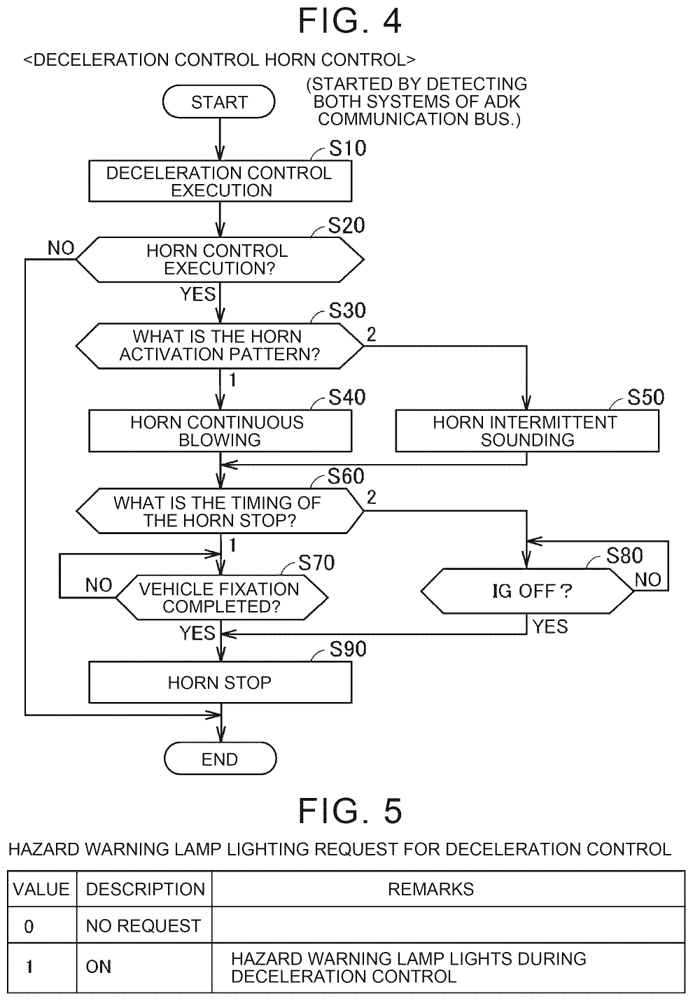

FIG. 4 is a flowchart illustrating an example of a procedure of horn control executed at the time of deceleration control. The series of processes shown in this flow chart is started when an anomaly in communication with both ADK 211A, 211B is detected.

Referring to FIG. 4, when an anomaly in communication with both ADK 211A, 211B is detected, VCIB 110 executes deceleration control for stopping the vehicle 1 (S10).

VCIB 110 then S20 to determine whether it is required to perform horn control to activate the horn during deceleration control. Specifically, VCIB 110 determines whether or not the value of API command (FIG. 3A) that requests blowing of the horn during deceleration control, received from ADK 200 prior to the occurrence of an error in communication with ADK 200, is 1. If it is determined that the number is not 1 (NO in S20), the subsequent series of processes is not executed, and the process proceeds to the end.

When it is determined in S20 that API command is 1 (YES in S20), VCIB 110 determines that the horn control is required to be executed, and confirms the horn operation pattern in the horn control (S30). More specifically, VCIB 110 checks API command (FIG. 3B) received from ADK 200 prior to the abnormal communication with ADK 200 requesting the horn's operating pattern in the horn control.

If it is determined in S30 that API command is 1 (“1” in S30), VCIB 110 outputs a command to continuously blow the horn to the body system 126 (FIG. 1) of the base vehicle 120 (S40). On the other hand, if it is determined in S30 that API command is 2 (“2” in S30), VCIB 110 outputs a command for intermittently sounding the horn to the body system 126 (S50).

VCIB 110 then S60 the stopping timing of the horn in the horn control. Specifically, VCIB 110 checks API command (FIG. 3C) that is received from ADK 200 and requires the stopping timing of the horn in the horn control prior to the abnormal communication with ADK 200.

When it is determined in S60 that API command is 1 (“1” in S60), VCIB 110 determines whether the fixing of the vehicle 1 is completed (S70). Then, when the fixing of the vehicles 1 is completed (for example, when the operation of EPB device or P-Lock device is completed) (YES in S70), VCIB 110 outputs a command for stopping the horn to the body system 126 (S90).

On the other hand, if it is determined in S60 that API command is 2 (“2” in S60), VCIB 110 determines whether or not the condition of the vehicle-system is IG-OFF (S80). Then, if it is determined that it is IG-OFF (YES in S80), VCIB 110 proceeds to step 90 and outputs a command for stopping the horn to the body system 126.

As described above, according to the first embodiment, it is possible to appropriately set, from ADK 200, whether or not to activate the horn at the time of deceleration control when an error occurs in communication with ADK 200 in accordance with the traveling area and other conditions.

Further, according to the first embodiment, the operation pattern and the operation termination timing of the horn in the horn control can be appropriately set from ADK 200 in accordance with the region and other conditions, taking into account the degree of attention to the surroundings and the effect of the sound of the horn on the surrounding environment.

### Second Embodiment

In the first embodiment, horn control at the time of deceleration control has been described. On the other hand, it is also conceivable to activate the hazard warning lamp of the base vehicle 120 for the purpose of calling attention to the surroundings of the vehicle during the deceleration control. However, as described above, it may be illegal to operate the hazard warning lamp unconditionally depending on the driving area.

In the second embodiment, a command is provided as to whether or not to execute the hazard warning lamp control for activating the hazard warning lamp when the deceleration control is executed, and such a command is given from ADK 200 to VCIB 110 of VP 100. In the following, the term “hazard warning lamp control” shall mean control to activate the hazard warning lamp when the deceleration control is executed. That is, VCIB 110 (VCIB 111A) is configured to receive a command from ADK 200 (ADK 211A) whether to perform hazard warning lamp control.

ADK 211A periodically transmits a command for instructing to execute the hazard warning lamp control to VCIB 111A according to the area in which the vehicles 1 are traveling. For example, when the vehicle 1 is traveling in an area where lighting of the hazard warning lamp during deceleration is not prohibited, ADK 211A periodically transmits a command for requesting lighting of the hazard warning lamp to VCIB 111A at the time of deceleration control. On the other hand, when the vehicle 1 is traveling in an area where lighting of the hazard warning lamp during deceleration is prohibited, ADK 211A transmits, to VCIB 111A, a command that does not require lighting of the hazard warning lamp at the time of deceleration control.

FIG. 5 is a diagram illustrating an API commanding for requesting lighting of a hazard warning lamp at the time of deceleration control according to the second embodiment. Referring to FIG. 5, this API command is for instructing whether or not to execute hazard warning lamp control from ADK 200 to VP 100 at the time of deceleration control. When the value of API command is 1, the hazard warning lamp is required to be turned on during deceleration control, and when the value is 0, the hazard warning lamp is not required to be turned on during deceleration control.

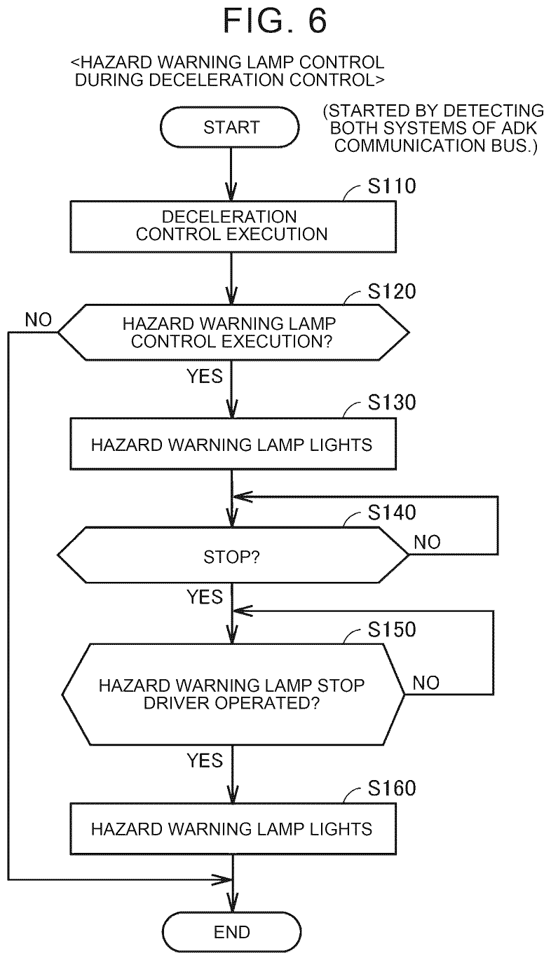

FIG. 6 is a flowchart illustrating an example of a processing procedure of hazard warning lamp control executed at the time of deceleration control. The series of processes shown in this flow chart is started when an anomaly in communication with both ADK 211A, 211B is detected.

Referring to FIG. 6, when an anomaly in communication with both ADK 211A, 211B is detected, VCIB 110 executes deceleration control for stopping the vehicle 1 (S110). Note that, as described in the first embodiment, the deceleration control may be executed in the base vehicle 120 (for example, using the brake system 121 and the active safety system 125) regardless of VCIB 110.

VCIB 110 then S120 to determine if a hazard warning lamp control is required to be performed to activate the hazard warning lamp during deceleration control. Specifically, VCIB 110 determines whether or not API command (FIG. 5) for requesting the lighting of the hazard warning lamp at the time of the deceleration control, which is received from ADK 200 prior to the occurrence of the abnormal communication with ADK 200, is 1. If it is determined that the number is not 1 (NO in S120), the subsequent series of processes is not executed, and the process proceeds to the end.

If it is determined in S120 that API command is 1 (YES in S120), VCIB 110 determines that the hazard warning lamp control is required to be executed. A command for turning on the hazard warning lamp is S130 to the body system 126 (FIG. 1) of the base vehicle 120.

Next, when the vehicle 1 stops (YES in S140), VCIB 110 determines whether or not there is a driver-operation for stopping the hazard warning lamp (S150). When the above-described driver is operated (YES in S150), VCIB 110 outputs a command for turning off the hazard warning lamp to the body system 126 (FIG. 1) of the base vehicle 120 (S160).

As described above, according to the second embodiment, it is possible to appropriately set, from ADK 200, whether or not to activate the hazard warning lamp at the time of deceleration control when an error occurs in communication with ADK 200 in accordance with the driving area or other conditions.

Further, according to the second embodiment, when the hazard warning lamp control is executed in accordance with a command from ADK 200, the hazard warning lamp can be stopped by the user of the vehicle. Therefore, it is possible to avoid a situation in which the hazard warning lamp is activated until the communication with ADK 200 is restored. The hazard warning lamp can be stopped by the user's intention.

Each of the embodiments disclosed herein may be combined as appropriate within a range not technically inconsistent. It should be understood that the embodiments disclosed herein are illustrative and non-restrictive in all respects. The technical scope indicated by the present disclosure is indicated by the claims rather than the description of the above-described embodiments, and is intended to include all modifications within the meaning and scope equivalent to the claims.

What is claimed is:

1. A vehicle that is configured to be equipped with an autonomous driving kit for generating a command for performing autonomous driving, the vehicle comprising:
a base vehicle that executes vehicle control in accordance with the command from the autonomous driving kit; and
a vehicle control interface box for performing communication with the autonomous driving kit, wherein
the vehicle is configured to execute deceleration control when an abnormality occurs in communication between the vehicle control interface box and the autonomous driving kit, and
the vehicle control interface box is configured to receive, from the autonomous driving kit, a command regarding whether to execute horn control for activating a horn of the base vehicle when the deceleration control is executed, or hazard warning lamp control for activating a hazard warning lamp of the base vehicle when the deceleration control is executed.

2. The vehicle according to claim 1, wherein the vehicle control interface box is configured to receive, from the autonomous driving kit, a command that instructs an operation pattern of the horn in the horn control.

3. The vehicle according to claim 1, wherein the vehicle control interface box is configured to receive, from the autonomous driving kit, a command that instructs an operation end timing of the horn in the horn control.

4. The vehicle according to claim 3, wherein the command that instructs the operation end timing includes a command that instructs that the operation end timing is a time at which the vehicle is fixed, or a command that instructs that the operation end timing is when the vehicle in system-off.

5. The vehicle according to claim 1, wherein the base vehicle is configured to accept a stopping operation of the hazard warning lamp by a user of the vehicle when the hazard warning lamp control is executed.
